(19) United States
(12) Patent Application Publication
(10) Pub. No.: US 2017/0070097 A1
(43) Pub. Date: Mar. 9, 2017

(54) ASSEMBLY FOR INDUCTIVE ENERGY TRANSFER

(71) Applicant: WITECH GMBH, Bielefeld (DE)

(72) Inventors: Maik-Julian BÜKER, Paderborn (DE); Tobias LÜCKE, Hoexter (DE); Jörg Rainer EUSKIRCHEN, Bielefeld (DE)

(21) Appl. No.: 15/123,051

(22) PCT Filed: Mar. 3, 2015
(86) PCT No.: PCT/DE2015/000097

§ 371 Date: Sep. 1, 2016

(30) Foreign Application Priority Data
Mar. 5, 2014 (DE) 10 2014 002 876.3

(51) Int. Cl. H02J 50/12; H02J 7/02

(52) U.S. Cl. CPC H02J 50/12; H02J 7/025

(57) ABSTRACT

An assembly for an inductive power transfer includes: a transmitter having a transmitting coil; and a receiver of an energy consumer. The receiver has: a receiver coil arrangement, the receiver coil arrangement including: a substrate having a first side and a second side, a first planar coil arranged on the first side of the substrate, and a second planar coil. The second planar coil has a different number of turns than the first planar coil and is arranged on the second side of the substrate opposite the first side of the substrate.

### CROSS REFERENCE TO RELATED APPLICATIONS

This is a U.S. national stage of application No. PCT/DE2015/000097, filed on Mar. 3, 2015. Priority is claimed on German Application No. 10 2014 002 876.3, filed Mar. 5, 2014, contents of which are incorporated herein by reference.

### BACKGROUND OF THE INVENTION

1. Filed of the Invention

The invention is directed to an arrangement, i.e., an assembly, for an inductive power transfer with a transmitter having at least one transmitting coil and a receiver of a consumer (i.e., an energy consumer) having a receiver coil arrangement.

2. Detailed Description of the Prior Art

Electric induction is often used for wirelessly transferring power between a stationary charging station and a mobile consumer. Accordingly, it is known in doors, for example, from EP 1 318 260 A2, to charge a battery moving along with the door leaf by inductive power transfer in a determined position of the door leaf.

Another field of application is described in U.S. Pat. No. 7,576,514 B2. A substantially two-dimensionally extending charging station with a plurality of transmitting coils serves to charge the batteries of mobile telephones, tablets or the like which are placed thereon.

In an inductive power transfer, a transmitting coil and a receiving coil can be optimized for the respective frequency, geometry and charge to be provided; however, if different consumers are connected to the receiver coil, efficiency generally suffers because the load resistances cannot be optimally matched to the receiver coil. As a result, additional electronic converter circuits are needed to make this possible.

### SUMMARY OF THE INVENTION

In view of the foregoing, it is an object of the present invention to provide an assembly for an inductive power transfer with a transmitter having at least one transmitting coil and a receiver of a consumer having a receiver coil arrangement, in which losses from, and constructional expenditure on, converters are reduced owing to a low output voltage without forfeiting efficient impedance matching.

According to an aspect of the invention, in an assembly for an inductive power transfer with a transmitter having at least one transmitting coil and a receiver of a consumer having a receiver coil arrangement, the set of technical problems mentioned above is solved in that the coil arrangement has two planar coils with a different number of turns arranged on both (i.e., opposite) sides of a substrate.

With an appropriate choice of substrate, the two coils are electrically coupled in a manner comparable to a transformer. A transformer type conversion of this kind directly in the receiver coil arrangement has the advantage that a lower output voltage can be supplied so that the losses in subsequent conversions can be reduced without having to forgo efficient impedance matching.

Any nonconductive plastic can be used as substrate. Particularly suitable are conventional circuit boards, foils or plastic housings of a consumer.

In one aspect, the preferred coil geometry is a rectangle, although other shapes are possible. Regardless, it is provided that the coils have congruent outer edges and inner edges of the outer turns and inner turns. Accordingly, the edges of the outer turns lie in a common, virtual tube, as it were, enclosed by the inner edges of the inner turns. As a result of these steps, a good coupling of the two coils is achieved on the one hand, and the influence of possible eddy currents is minimized.

A further advantage of a receiver coil arrangement of this type consists in that the electronic circuit of the receiver can be formed so as to be offset from the substrate. In this way, the receiver coil arrangement manifests as a very flat component outfitted only with the component parts which determine the resonance of the coils and which are hardly bulky when carried out in SMD (surface mount device) technology.

It is further provided that one side of the substrate with a first coil having a higher number of turns than the second coil is arranged, opposite the transmitting coil, in or on the consumer. This first coil is the actual receiver coil, but forms a resonant circuit merely by interconnection with a capacitor. The number of turns is determined substantially through the transmission frequency. For example, with a transmission frequency of between 1 MHz and 10 MHz, the number of turns is between 8 and 15.

The number of turns of the second coil is appreciably lower and is determined by the level of output voltage. The consumer is fed by this second coil having a lower number of turns. Given the operating parameters mentioned above, the number of turns of the second coil can amount to 2 to 4, for example.

It has proven advisable that the power supply of the receiver, particularly a microcontroller, is tapped at a center tap of the second coil having the low number of turns. Accordingly, the power supply of the receiver and the power supply of the consumer are separate.

It can be provided for operating the assembly according to an aspect of the invention that the first coil is tuned to resonance or, alternatively, that the second coil is tuned to resonance and the first coil is operated slightly off resonance.

If the side of the substrate carrying the first coil faces the transmitting coil, the side of the substrate carrying the second coil generally faces the interior of the consumer. Therefore, it is advisable to provide a plate-like shielding of ferrite for the side of the substrate carrying the second coil. In this way, the interior of the consumer is largely shielded from the inductive power transfer.

### BRIEF DESCRIPTION OF THE DRAWINGS

Embodiments of the invention will be described more fully with reference to the drawings in which embodiment examples are only shown schematically in a simplified manner. In the drawings:

FIG. 1 is an electric equivalent circuit diagram;

FIG. 2 is a top view of a substrate provided with the receiver coil arrangement; and

FIG. 3 is a bottom view of the substrate provided with the receiver coil arrangement.

### DETAILED DESCRIPTION OF THE PRESENTLY PREFERRED EMBODIMENTS

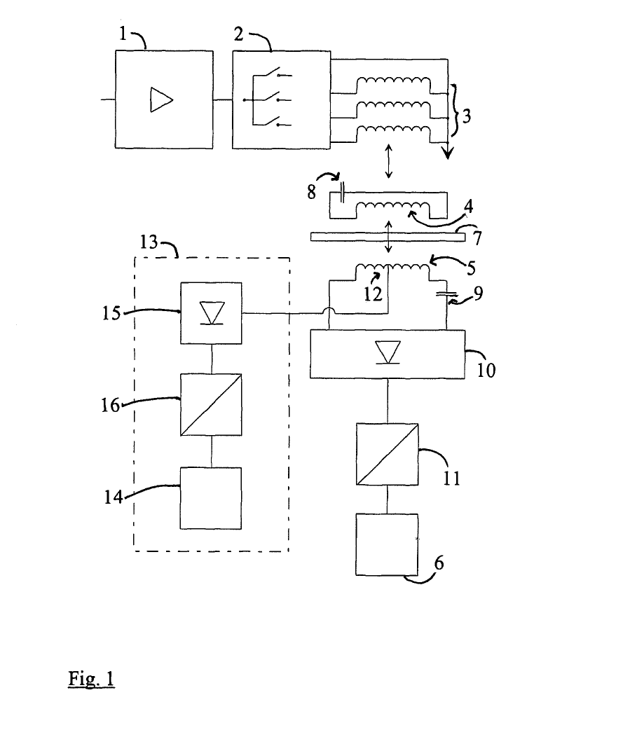

A transmitter 1 is shown schematically in an equivalent circuit diagram in FIG. 1. This transmitter 1 applies voltage, via a control circuit 2, to a plurality of transmitting coils 3, indicated by the arrow, individually or in groups for an inductive power transfer.

As is indicated by the double arrow, the inductive power transfer is carried out proceeding from the transmitting coils 3 to a receiver coil arrangement with a first coil 4 and a second coil 5 for the power supply of a consumer 6, particularly a mobile consumer 6. The first coil 4 and second coil 5 are arranged in a planar manner on both, i.e., opposite, sides of a substrate 7, as will be described in more detail below. Owing to this coil arrangement, the first and second coils 4, 5 are electrically coupled in the manner of a transformer. This is indicated by the double arrow.

If the first coil 4 merely forms a resonant circuit with a capacitor 8, the voltage for the consumer 6 is tapped at the second coil 5. This takes place in a conventional manner, per se, via a capacitor 9, a rectifier circuit 10 and a DC/DC converter 11 for fine adjustment of the supply voltage of the consumer 6.

Accordingly, the second coil 5 has appreciably fewer turns than coil 4.

Aside from the connections for supplying the consumer 6, the second coil 5 has a center tap 12 from which the receiver circuit 13 is supplied. The receiver circuit 13 is represented here by way of example as microcontroller 14, a rectifier 15 and a DC/DC converter 16 being connected upstream thereof.

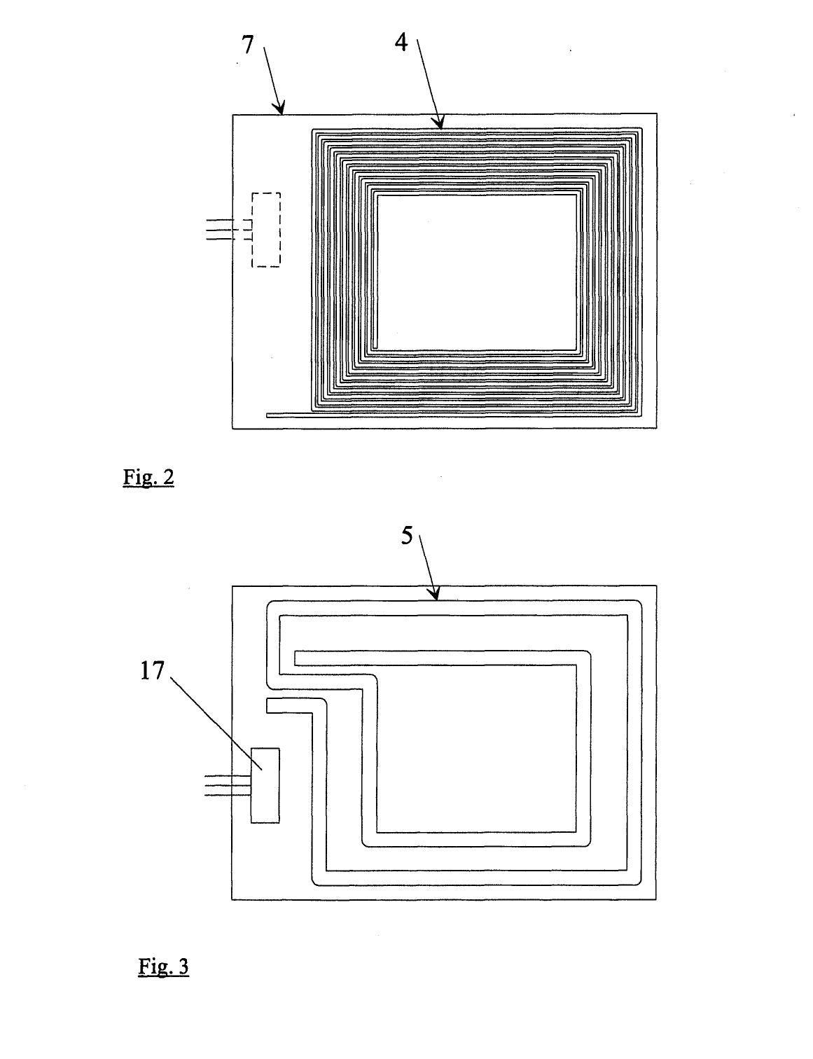

FIGS. 2 and 3 show views of the substrate 7, for example, a circuit board, carrying the coils 4 and 5. A top view according to FIG. 2 shows a first coil 4 with turns, for example, eleven turns, for an inductive power transfer at a frequency of 1 MHz to 2 MHz. The second coil 5 is arranged exactly opposite on the underside of the substrate 7 and has two turns in this case only by way of example.

In addition to the two coils 4, 5, the circuit board or substrate 7 carries only the capacitors 8, 9 and, in this case by way of example, a plug strip 17 for connecting the receiver circuit 13.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-10. (canceled)

11. An assembly for an inductive power transfer, comprising:
a transmitter (1) having a transmitting coil (3); and
a receiver (13) of an energy consumer (6), the receiver (13) having:
a receiver coil arrangement, the receiver coil arrangement including:
a substrate (7) having a first side and a second side,
a first planar coil (4) arranged on the first side of the substrate (7), and
a second planar coil (5), the second planar coil (5) having a different number of turns than the first planar coil (4) and being arranged on the second side of the substrate (7) opposite the first side of the substrate (7).

12. The assembly according to claim 11, wherein the first and second planar coils (4, 5) have congruent outer edges and inner edges of outer turns and inner turns of the respective planar coils.

13. The assembly according to claim 11, the receiver (13) having an electronic circuit, the electronic circuit of the receiver (13) being arranged so as to be offset from the substrate (7).

14. The assembly according to claim 11, wherein the first planar coil (4) has a higher number of turns than the second planar coil (5), and the first planar coil (4) is arranged, in or on the energy consumer (6), opposite the transmitting coil (3).

15. The assembly according to claim 11, wherein the energy consumer (6) is fed by the second planar coil (5).

16. The assembly according to claim 15, wherein the receiver (13) has a power supply, and the power supply of the receiver (13) is tapped at a center tap (12) of the second planar coil (5).

17. The assembly according to claim 11, wherein the first planar coil (4) is tuned to resonance.

18. The assembly according to claim 11, wherein the second planar coil (5) is tuned to resonance and the first planar coil (4) is operated slightly off resonance.

19. The assembly according to claim 11, wherein a transmission frequency of inductive power transfer is between 1 MHz and 10 MHz.

20. The assembly according to claim 11, further comprising a plate-like shielding of ferrite arranged on the substrate for the second planar coil (5).
